(19) United States
(12) Patent Application Publication
(10) Pub. No.: US 2004/0238301 A1
(43) Pub. Date: Dec. 2, 2004

(54) Method for emptying a hydrodynamic retarder in an accelerated manner and hydrodynamic retarder

(76) Inventors: Kai Kamossa, Crailsheim (DE); Achim Neher, Crailsheim (DE); Karl Mondorf, Crailsheim (DE); Dieter Laukemann, Vellberg (DE); Adams Werner, Crailsheim (DE)

Correspondence Address: Charles N J Ruggiero, Ohlandt Greeley Ruggiero & Perle, 10th Floor, One Landmark Square, Stamford, CT, 06901-2682, US

(21) Appl. No.: 10/483,508

(22) PCT Filed: Jul. 8, 2002
(86) PCT No.: PCT/EP02/07576

(30) Foreign Application Priority Data
Jul. 12, 2001 (DE) 101 33 342.0

(51) Int. Cl. F16D 57/02

(52) U.S. Cl. 188/290; 188/296

(57) ABSTRACT

A method and apparatus for accelerated emptying of an operating substance from the working chamber of a hydrodynamic retarder is provided which uses a gaseous medium that is introduced into the working chamber to induce volume displacement.

The invention concerns a method for emptying a working chamber of a hydrodynamic retarder in an accelerated manner according to, in detail, the features of the preamble of claim 1; further, it concerns a hydrodynamic retarder.

Hydrodynamic retarders are known, for example, from VDI Handbuch Getriebetechnik II [“VDI Handbook of Gear Engineering”], “VDI Guidelines” VDI 2153, “Hydrodynamic Power Transmission: Terminology—Designs—Modes of Operation, Chapter 7, Brakes,” or Dubbel, Taschenbuch für den Maschinenbau [Handbook of Mechanical Engineering], 18th edition, pages R49 to R53, the disclosure content of which is incorporated to the full extent into this application. Particularly when they are used in motor vehicles or in equipment with strongly varying operation, retarders of this kind are switched on and off by filling and emptying the blade-mounted operating circuit with an operating fluid. The emptying takes place by interruption of the feed of operating substance to the working chamber owing to the pumping action of the rotation of the rotor-blade wheel. However, because of the dependence on the rotational speed of the rotor, an important drawback of this method exists in that, on the one hand, the working chamber of the retarder is not emptied completely after braking and, on the other hand, the emptying does not occur fast enough. Thus, even when the retarder is switched off, a residual moment may still exist on account of, for example, a circulating residual quantity of oil. Even though the braking moment due to the residual moment is very small, it can have a very disruptive effect at high speeds of rotation and lead to an impermissibly high heating of the retarder. In order to prevent ventilation losses, a number of solutions are already known. These include, among others, the use of stator bolts as well as the possibility of a complete evacuation of the circuit.

Known, in addition, from the document DE 198 60,706 A1 is a hydrodynamic retarder in which the chamber between the outlet and the outlet valve is specifically emptied in order to prevent a filling of the working chamber of the retarder during non-braking operation at low speeds of rotation. This is effected by having pressure pulses act upon this chamber. However, this solution serves only to influence the ventilation losses after emptying has occurred and has no influence on the duration of the actual emptying process.

Therefore, the invention is based on the problem of providing an arrangement by means of which, independent of the speed of rotation of the retarder, there is always achieved a rapid as possible emptying of the working chamber of the hydrodynamic retarder or a partial emptying when a reduction in the braking moment is desired.

The solution in accordance with the invention is characterized by the features of claims 1 and 18. Advantageous embodiments are described in the subclaims.

In accordance with the invention, an acceleration of the emptying of operating substance from the working chamber formed between the rotor and the stator of a hydrodynamic retarder is achieved by introducing a gaseous medium, preferably under pressure or subject to the gear action that sets in based on the rotor rotation during the emptying or an opened outlet valve, into the working chamber during the emptying process. By this means, on the basis of the volume displacement, a pressure is exerted on the operating substance present in the working chamber, this leading to an increase in the volume flow through the operating-substance outlet.

Accordingly, in the solution in accordance with the invention, the point in time until the adjustment of a reduced braking moment or until the deactivation of the hydrodynamic retarder is substantially shortened. Other systems that are dependent on this process, particularly the antilock [brake] system, can thus work in an optimal manner.

The possibility of exploiting the outflow effect due to the rotation leads here to an acceleration of the emptying process. The introduction under pressure—that is, an injection, as it were—also serves, in addition to accelerating the emptying process, to attain the proper or desired level of emptying.

Here, the introduction of the gaseous medium, which exists under pressure, into the working chamber takes place at the same time as or with a slight delay to the initiation of the emptying process. The period of time during the emptying process extends from its beginning up to the time when complete emptying has been attained or else up to the time when a defined low degree of filling has been reached. The beginning of the emptying process is characterized here, for example, by the transmission of a signal indicating the desire of the driver or the transmission of a command from a vehicle control computer to reduce the braking moment or else to deactivate the braking device. The corresponding processing times of these signals in a control device must also be considered.

Finding use as gaseous medium is, above all, air, which is utilized from other systems when the retarder is employed in drive systems of vehicles or stationary equipment. In the process, the exhaust air from control functions, in particular the exhaust air of the valve control mechanism, is one thing that finds use.

The gaseous medium may be present in an unpressurized state and only be compressed in a compressor, for example, prior to being introduced into the working chamber. According to a particularly advantageous embodiment, the gaseous medium already exists in the compressed state as the waste product of pneumatic control mechanisms of actuating devices or other systems of the drive system in which the hydrodynamic retarder is integrated. In this case, no additional compressed gas generators and reservoirs are provided. The components present in the system are utilized.

Under a further aspect of the invention, the introduction and the displacement effect thereby produced can be controlled. To this end, the gaseous medium under pressure can be varied in terms of its quantity and/or the magnitude of its pressure. The introduction of gaseous medium under pressure into the working chamber takes place preferably in the form of pulses or, at the least, as one pulse.

In accordance with a particularly advantageous embodiment, the introduction of gaseous medium takes place through already existing channels and openings to the working chamber of the retarder in order to reduce the construction expenditure. In the process, the introduction can take place

a) through the operating-substance inlet into the working chamber

b) for designs of a retarder with at least one ventilation channel in the blade

mounting of the stator and/or the rotor, which opens into the blade base and from this into a chamber towards the outside of the blade wheel, through this channel.

For designs of hydrodynamic retarders with an extended working chamber, which is situated downstream from the operating-substance outlet, in front of the outlet chamber, which is associated with an outlet valve, the gaseous medium that is introduced into the working chamber under pressure is characterized in terms of its characteristic parameters of density, pressure, and/or temperature and/or volume in such a way that at least a partial and preferably a complete volume displacement of the operating substance present in the outlet chamber is also achieved.

In accordance with the device, the hydrodynamic retarder comprises a retarder housing, a stator, and a rotor, which together form a working chamber, as well as at least one operating-substance inlet into the working chamber and one operating-substance outlet out of the working chamber. In accordance with the invention, means for injecting or for introducing gaseous medium under pressure into the working chamber are provided. These include at least one connecting line, which couples the medium source to an inlet for the gaseous medium into the working chamber.

The means for injecting or for introducing gaseous medium under pressure into the working chamber comprise means for compressed-gas generation, possibly a reservoir for the compressed gaseous medium, and at least one connecting line, through which the means for compressed-gas generation or the reservoir can be connected by way of the inlet for gaseous medium to the working chamber. The feed of compressed gas can take place in a free manner. In this case, the means for compressed-gas generation include at least one compressor and the reservoir for the compressed gaseous medium is designed as a pressurized-substance reservoir. Here, as a rule, means for controlling the connection between the reservoir and the working chamber are provided in the connecting line.

When the exhaust air of other systems or of the retarder itself is exploited, the means for compressed-gas generation are formed from these themselves, in particular the actuating devices for these, such as, for example, a pneumatically controlled actuating or valve device, the waste product of which, in the form of compressed exhaust air, constitutes the compressed gaseous medium. In this case, no separate reservoir is required and only the provision of a corresponding connecting line is needed.

It is especially advantageous when, as inlet for the gaseous medium, elements or channels that are already present can be utilized, such as, for example, the operating-substance inlet or else the channels that are already present for lateral ventilation and which are arranged in the blade mounting of individual blade wheels. Provided in this case are only means for functional assignment of the corresponding inlet openings or lateral ventilation channels.

If the inlet for the gaseous medium is formed by the operating-substance inlet, means must be provided for the selective coupling of the line that is coupled with the operating-substance inlet to a line carrying operating substance or to the means for introducing gaseous medium under pressure into the working chamber. In the simplest case, these include a valve device that is associated with the line coupled to the operating-substance inlet and that has at least two switching positions—a first switching position and a second switching position, wherein, in the first switching position, the feed of operating substance to the operating-substance inlet is interrupted. The connecting line is then coupled to the line that is coupled to the operating-substance inlet between the valve device associated with this line and the operating substance inlet.

Another possibility exists in coupling the connecting introduction to the inlet line and in blocking the feed of operating substance through the inlet line in front of the junction of the connecting line and the inlet line in the feed direction of the operating substance.

If the admission of pressurized substance takes place through the ventilation channels, then means for the control of the function as ventilation channel or inlet for the gaseous medium are assigned to the ventilation channels. In the simplest case, this function is realized by way of a ventilation system line that is coupled to a ventilation channel and means for the selective coupling of the line that is coupled to the ventilation channel or the means for introducing gaseous medium under pressure to the working chamber, whereby the line that is coupled to the ventilation channel is associated with a valve device with at least two switching positions—a first switching position and a second switching position—and, in the second switching position, the ventilation channel is blocked. The connecting line is then coupled to the line that is coupled to the ventilation channel between the valve device associated with this line and the ventilation openings at the beginning of the ventilation channel.

The solution in accordance with the invention can further be used also for at least partial emptying into the outlet chamber when a hydrodynamic retarder is designed with means for adjusting an optimal degree of filling with respect to the minimization of power loss in non-braking operation of the working chamber and possibly of the extended working chamber situated downstream from this working chamber and it can be used for nearly complete emptying of the working chamber. To this end, the means for adjusting the optimal degree of filling include an outlet, which is arranged radially inwards at a geodetically elevated location for designs with extended working chamber and/or, for designs without extended working chamber, and thus is arranged so as to oppose the centrifugal force in the working chamber, so that, when the brakes are emptying, no more working liquid can flow out of the working chamber beyond a predetermined optimal degree of filling. In the process, the outlet channel for adjusting the optimal degree of filling can be arranged horizontally at such a height h that the retarder is not completely emptied, but rather, even in non-braking operation, a certain quantity of retarder working fluid remains in the retarder. In an alternative embodiment to a horizontal arrangement of the outlet channel at a height h, it can be provided that the outlet channel is a tube with the height h that extends vertically into the working chamber or into the extended working chamber. The solution in accordance with the invention is utilized here for the purpose of specifically emptying the chamber between the outlet from the working chamber or, in the case of a design with extended working chamber, the chamber between the outlet from the latter and the outlet valve and for the purpose of preventing a filling of the retarder working chamber in non-braking operation at low speeds of rotation as well as of achieving a very low power loss at high speeds of rotation.

The solution in accordance with the invention will be illustrated in the following on the basis of figures. Represented there in detail are the following:

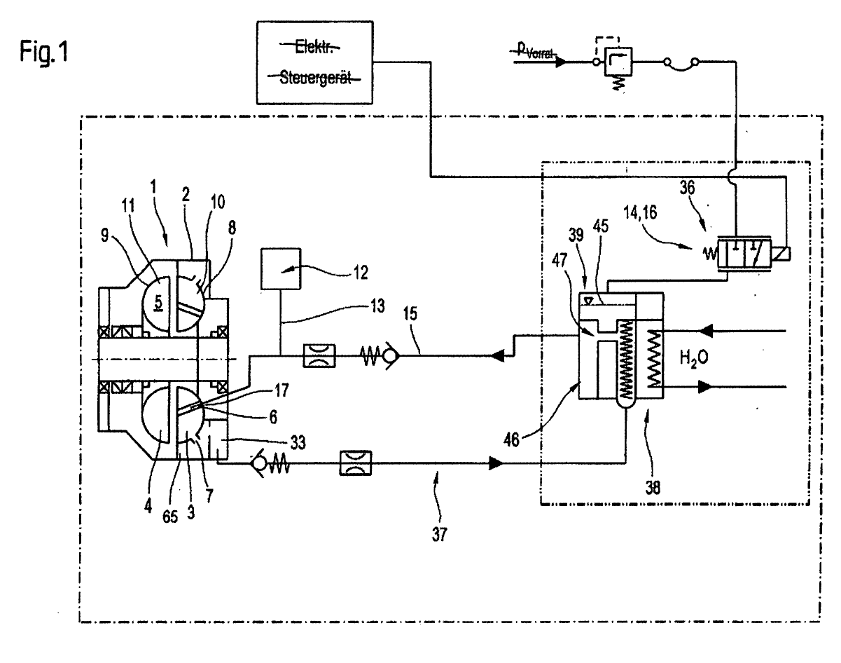

FIG. 1 elucidates, in a schematically simplified representation, a first embodiment of a solution realized in accordance with the invention;

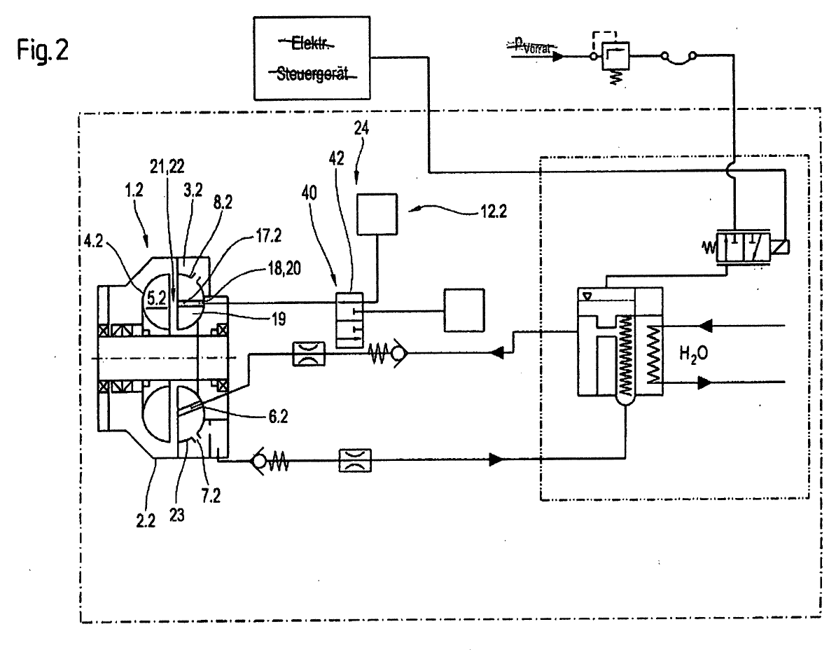

FIG. 2 elucidates, in a schematically simplified representation, a second embodiment of a solution realized in accordance with the invention;

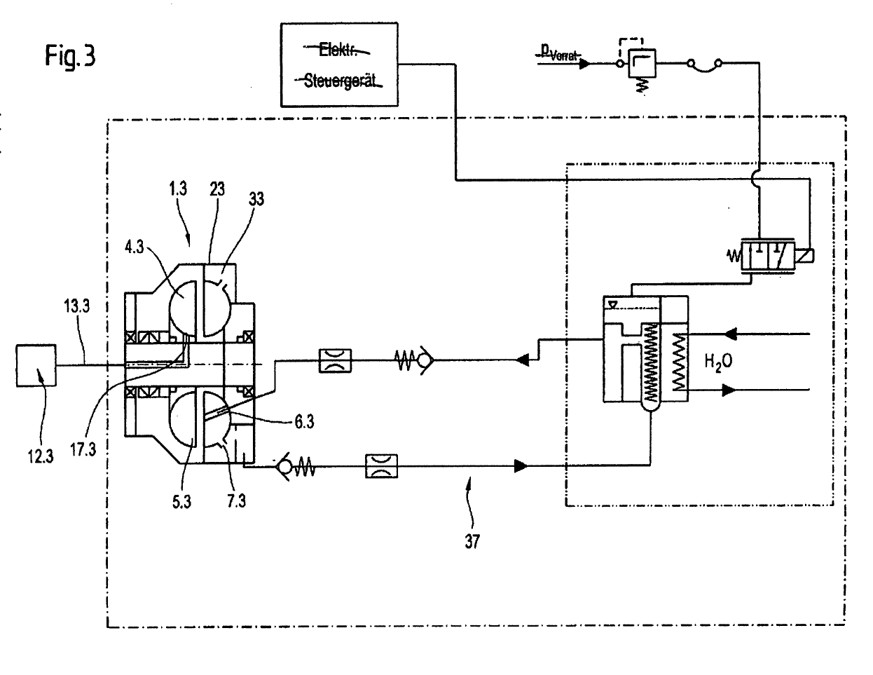

FIG. 3 elucidates, in a schematically simplified representation, a third embodiment of a solution realized in accordance with the invention;

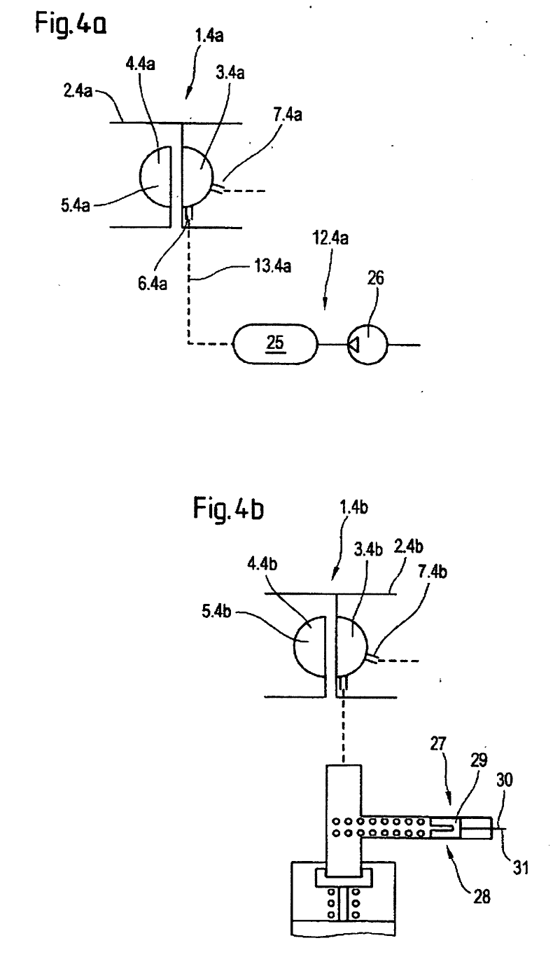

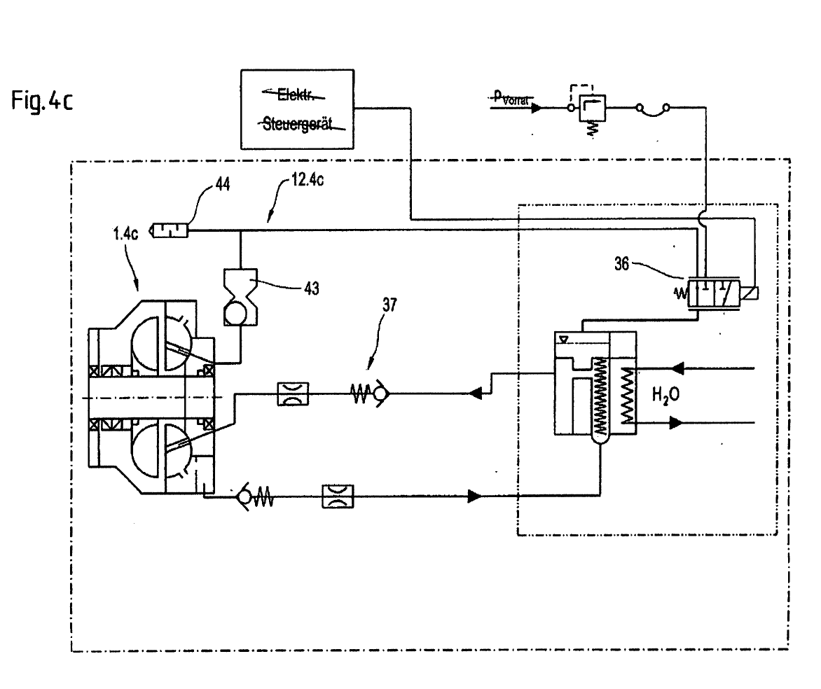

FIGS. 4a to 4c elucidate possible embodiments of the means for introducing gaseous medium into the working chamber under pressure;

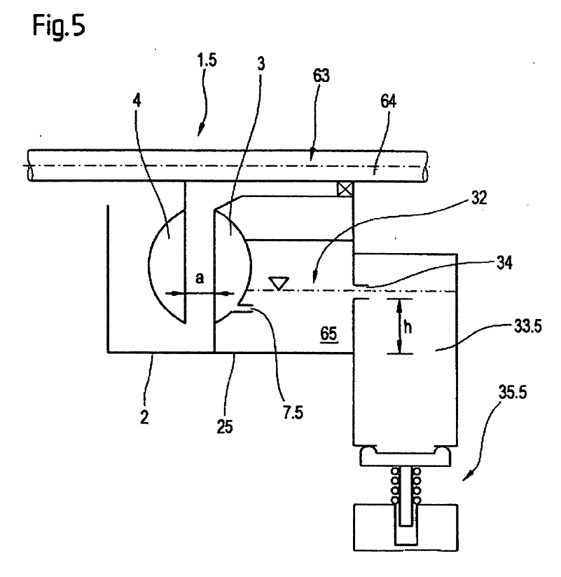

FIG. 5 elucidates a possible application of the solution in accordance with the invention in the embodiment of a retarder with an outlet chamber;

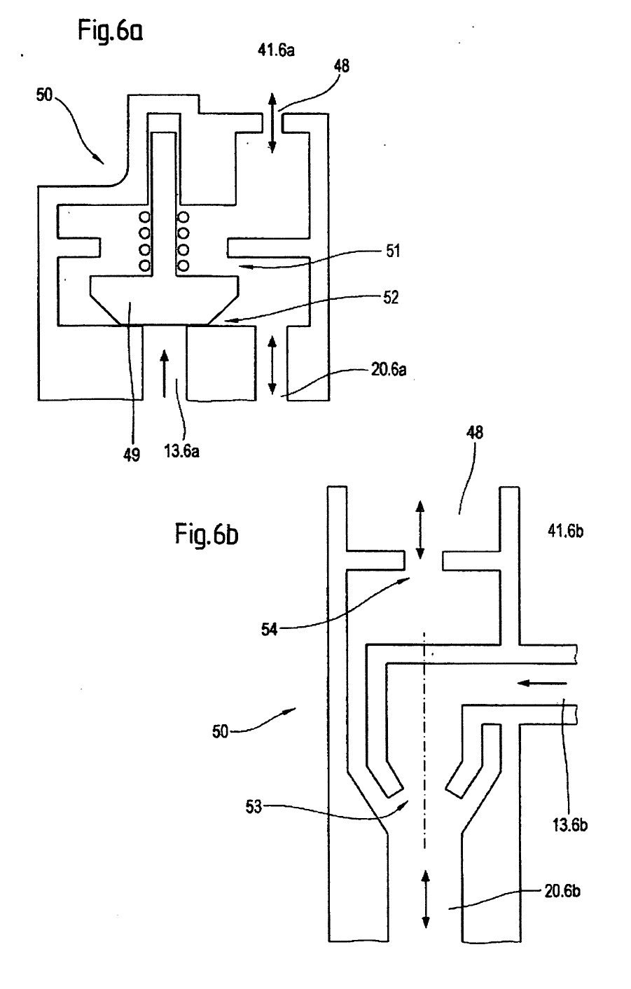

FIGS. 6a and 5b elucidate possible embodiments of a pulse valve device;

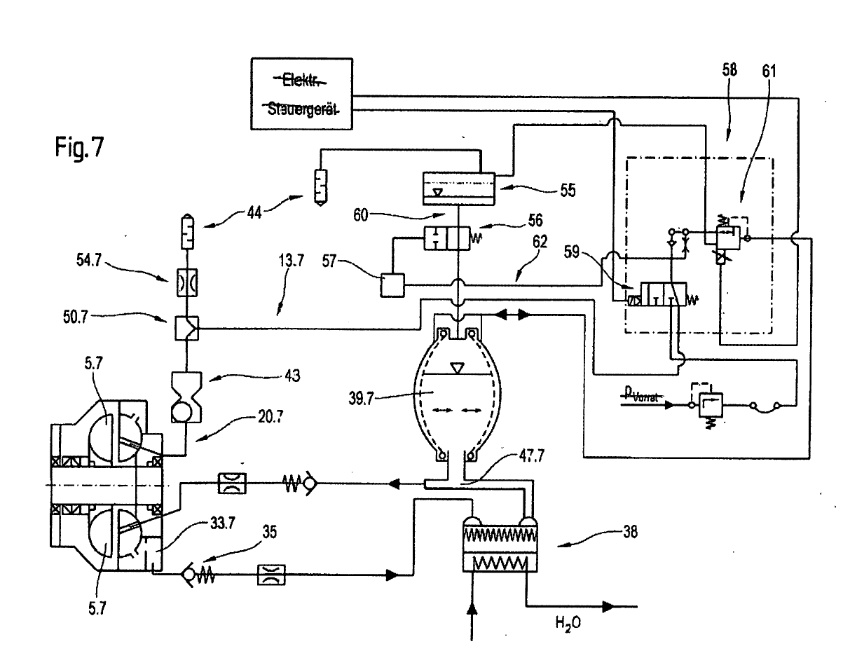

FIG. 7 elucidates an embodiment of the solution in accordance with the invention with exploitation of the exhaust air as gaseous medium from a valve control mechanism;

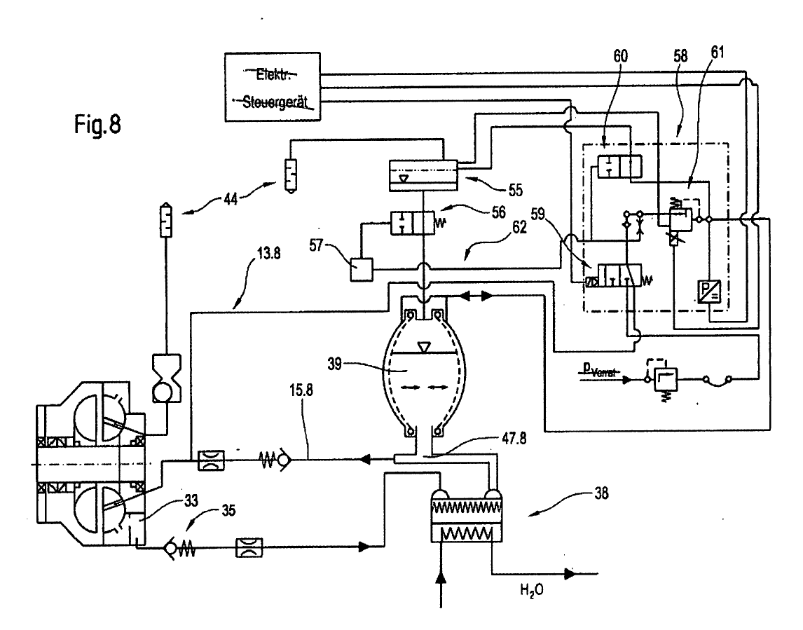

FIG. 8 elucidates an embodiment according to FIG. 7 for introducing a gaseous medium into the feed channel.

Represented in FIG. 1, on the basis of a sectional drawing in schematically greatly simplified representation, is a first embodiment of the solution in accordance with the invention. The hydrodynamic retarder 1 comprises a retarder housing 2, a stator 3, and a rotor 4. The stator 3 and the rotor 4 form a working chamber 5, which is shaped in the form of a torus. In it, operating substance is caused to revolve during the operation of the hydrodynamic retarder 1 for the purpose of generating a braking moment. For this purpose, the stator 3 is mounted in a fixed manner in the housing or in a stationary manner. The rotor 4 is mounted in a rotating manner and is coupled in a rotating manner with a rotating driving or driven element. In order to produce a braking moment, it is necessary to introduce an operating substance, which, as a rule, is oil, into the working chamber 5. This takes place through at least one operating-substance inlet 6 to the working chamber 5. A reduction of the braking moment takes place through the partial emptying of the torus-shaped working chamber and the transition to non-braking operation takes place through the emptying of the torus-shaped working chamber 5. For this purpose, the hydrodynamic retarder 1 has at least one operating-substance outlet 7 from the torus-shaped working chamber 5. The operating-substance inlet is arranged, as a rule, at the rotor 4, while the operating-substance outlet 7 is arranged at the stator 3. In the case represented, the inlet 6 is arranged at the stator 3. Here, it is unimportant whether the operating-substance inlet 6 or the operating-substance outlet 7 is arranged in the blade base 8 or 9, respectively, of the blade mounting 10 or 11, respectively, of the stator 3 or the rotor 4, respectively, in the areas that are free from the blade mounting 10 and 11 or else in at least one blade of the blade mounting 10 or 11, respectively. The concrete form of the operating-substance inlet 6 or the operating-substance outlet 7 lies within the discretion of the responsible person skilled in the art. For braking, in the case shown, control air is fed through a valve device 36 onto the surface of the working medium 45, this control air pressing the working medium through an ascending channel 46 and the inlet line 15 into the working chamber 5 of the retarder. This working medium is fed again by means of the pumping action of the rotor through the operating-substance outlet 7, the extended working chamber 65, and the return line 37 and the heat exchanger 38 to a junction 47, whereby the braking-cooling cycle is completed and is maintained by means of the pressure imposed at the junction 47 and the pumping action of the rotor. The turnover of the operating substance and the braking moment of the retarder are essentially dependent on the pressure of the control air.

For deactivation of the hydrodynamic retarder 1, that is, the desired termination of a braking process, the feed stream of operating substance to the working chamber 5 through the operating-substance inlet 6 is interrupted, in order to switch off the hydrodynamic retarder 1, by taking away the control pressure from the surface of the working medium 45. The working medium that arrives at the junction 47 through the return line 37 and the heat exchanger 38, in the absence of a pressure that is further imposed by way of the ascending channel 46 at the junction 47, essentially no longer flows through the inlet line 15 into the retarder but rather through the ascending channel into the operating-substance reservoir 39. The working circulation present in the working chamber 5 automatically empties, on account of the pumping action due to rotor rotation, through the return line 37 into an operating-substance reservoir 39. This is also true, analogously, for the desired reduction in the braking moment brought about by the hydrodynamic retarder 1. Of great importance, however, is the period of time until the reduced braking moment or the complete deactivation of the hydrodynamic retarder 1 sets in; in order to ensure an optimal mode of operation of other systems, such as, for example, an antilock [brake] system, this period of time is to be kept as short as possible. In accordance with the invention, in order to accelerate the emptying process during reduction of the braking moment or during deactivation of the hydrodynamic retarder 1, a gaseous medium is forced into the working chamber 5; that is, the gaseous medium is introduced into the working chamber 5 under pressure. In the working chamber, this makes possible a volume displacement, which produces an accelerated transition of the operating substance from the working chamber 5 into the operating-substance outlet 7. Provided for this purpose are means 12 for injecting or introducing a gaseous medium, preferably under pressure, into the working chamber 5, these means being designated as 12 and including at least one connecting line 13, which makes possible the coupling between a source for the gaseous medium and the working chamber 5, in particular the inlet 17 for gaseous medium. The means 12 for injecting or introducing a gaseous medium under pressure into the working chamber 5 can be designed in a number of ways. It is essentially dependent on the source from which the gaseous medium comes. These possibilities are not indicated further in FIGS. 4a and 4b. Air is preferably used as the gaseous medium.

In accordance with a first embodiment, as represent in FIG. 1, the means 12 for introducing the gaseous medium under pressure into the working chamber 5, in particular a source for the gaseous medium, are connected through the connecting line 13 to the operating-substance inlet 6, which accordingly functions as inlet 17 for the gaseous medium. To this end, the means 14 for the selective coupling of the operating-substance inlet 6 to an inlet line 15 carrying operating substance and the means for introducing a gaseous medium under pressure, 12, into the working chamber 5 are provided. The means for the selective coupling, 14, includes, in the simplest case, a valve device 16 in the form of a distributing valve, this function being assumed, in the case represented, by the valve device 36 in outlet position. Here, the connecting line 13 can either be coupled directly to the operating-substance inlet 6 or else it can be coupled to a partial section of the inlet line carrying the operating-substance. This means that also sections of the inlet line or inlet chambers carrying operating substance can be used as well for conveying the gaseous medium. In this case, however, it is necessary that these regions for conveying the gaseous medium be constructed in a pressure-tight manner.

In the embodiment represented in FIG. 1, it is only important that, here, the introduction of the gaseous medium under pressure into the working chamber 5, preferably in the form of air, takes place through the operating-substance inlet 6 that is usually required for filling the retarder 1 when the hydrodynamic retarder 1 is operated for generating a braking moment. Accordingly, there exists here the possibility of utilizing already existing feed channels that are not utilized in this operating state. Here, it is not important in what form the inlet or the operating-substance openings to the torus-shaped working chamber 5 are themselves designed, in particular whether these are arranged in the blade base 8 and 9, as represented schematically in FIG. 1, or else are arranged in the blade mounting 11 of the rotor 4.

In contrast to this, FIG. 2 discloses a further embodiment for implementation of the solution in accordance with the invention, which can be implemented in addition to or alternatively to that represented in FIG. 1. The basic design of the hydrodynamic retarder 1 corresponds to that described in FIG. 1. Therefore, the same reference characters are used for the same elements. Here, the hydrodynamic retarder 1.2 likewise comprises a stator 3.2 and a rotor 4.2, which together form a working chamber 5.2. At least one operating-substance inlet 6.2 and one operating-substance outlet 7.2 are associated with the working chamber 5.2. The means 12.2 for introducing a gaseous medium under pressure into the working chamber 5.2 is coupled here, too, via an inlet 17.2 for the gaseous medium into the working chamber 5.2. In contrast to the embodiment represented in FIG. 1, the inlet 17.2 here for the gaseous medium is formed from openings or channels 18, which connect the working chamber 5.2 to a chamber outside, such as, for example, a chamber in the retarder housing 2, for the purpose of ventilating the working chamber 5.2. In the case represented, the blade mounting 10.2 of the stator 3.2 has at least one ventilation blade 19, which carries a ventilation channel 20, which connects the core chamber 21, that is, the inner chamber 22, of the working chamber 5.2 to a chamber in the retarder housing 2.2. Here, the ventilation channel 20 or the ventilation channels 20.1 to 20.n each extend from the blade end of a ventilation blade 19 to the blade base 8.2 and through the wall 23 of the stator 3.2. The means for introducing gaseous medium under pressure, 12, into the working chamber 5 can be integrated into the retarder housing 2 in this case. Preferably, when compressed substance sources that are already present in vehicle use are exploited, these are arranged outside of the retarder housing 2, but are joined in a pressure-tight manner to the hydrodynamic retarder 1. Utilized here, too, are already present elements and channels of the hydrodynamic retarder 1, which are not utilized in other ways in the operating state for partial emptying of the working chamber 5.2 or for emptying of the working chamber 5.2 in order to produce a reduced braking moment, because these channels and chambers, which, in this case, are the channels existing for lateral ventilation during the filling process, are each utilized in other operating states and thus there does not exist any conflict between the different utilizations in one operating state. In order to couple the channels 20 to the means 12, means 40 for selective coupling of the ventilation channel 20 or of the channels to a pressure-relief chamber 41, such as a chamber in the retarder housing 2.2 or one outside it, for example, are provided. These are designed, in the simplest case, as valve devices 42.

The two solutions represented in FIGS. 1 and 2 therefore represent particularly advantageous solutions. However, it is also conceivable, as represented in FIG. 3, to couple the means for introducing gaseous medium under pressure, 12.3, into the working chamber 5.3, through a separate inlet 17.3 for the gaseous medium, to the working chamber 5.3. Provided in this case for the supply with gaseous medium is a separate line connection, which requires no means for functional assignment of individual parts of the line, as represented in FIGS. 1 and 2. Particularly in the case of the solution represented in FIG. 2 as well, only line connections of the lateral ventilation system are utilized, wherein, for coupling the means for introducing the gaseous medium under pressure, 12, into the working chamber 5 at the openings or channels 18 in the ventilation blades 19, means 24 are to be assigned for the control of the utilization of the line connection or of parts thereof in the form, for example, of the valve device 40.

FIGS. 4a and 4b elucidate, in a schematically greatly simplified representation, two possible embodiments of the means 12.4a and 12.4b, respectively, for introducing gaseous medium, preferably under pressure, into the working chamber 5. The sources for the gaseous medium are each coupled here through the connecting lines 13.4a and 13.4b, to an inlet 17.4a and 17.4b, respectively, for the gaseous medium in the working chamber 5.4a and 5.4b, respectively. Here, the term connecting line is not to be understood to the effect that only lines are meant here, but also channels passing through positionally fixed elements and combinations made up of line connections and channels, that is, only the coupling between the means 12.4 and 12.4b and the inlet 17.4a and 17.4b respectively.

In the possibility represented in FIG. 4a, the means (12.4a) for introducing gaseous medium, preferably under pressure, into the working chamber 5.4a include a source in the form of a reservoir in the form of an air tank 25, which is coupled through the connecting line 13.4a to the inlet 17.4a. A compressor device 26 is provided for making available gaseous medium under pressure. Here, the air tank can involve the compressed-air tank of the vehicle or else a separate component to which air under pressure is fed. In this case, the air fed in can be the exhaust air required for producing the control functions and the valve functions. However, it can also be fed directly to the working chamber without intermediate storage.

A further possibility for configuring the means 12.4b is represented in FIG. 4b. This consists of a means for generation of pressure pulses 27. The means for the generation of pressure pulses 27 comprise a pressure pulse cylinder 28, which has a piston 29 acted upon by pressure. Given a suitable position and a suitable design of the pressure pulse cylinder, in particular the ratio of the length to the diameter, it is also possible to dispense with the piston. The pressure pulse cylinder has the function of bringing a pressure pulse into the working chamber 5.4b. When a pressure pulse is applied, the working medium, which, in the present case, is oil, is emptied through the operating-substance outlet 7.4b. The air connection 30 to a source of gaseous medium in the form of a pressure reservoir, which is required for the operation of the pulse cylinder 28, is only indicated in the present case by way of the line 31. Here, too, the pressure reservoir can be formed from a compressed-air tank or compressed-air container that is already present in the vehicle.

FIG. 4c elucidates, on the basis of an embodiment in accordance with FIG. 1, a possibility for exploiting the exhaust air from a valve control mechanism, in particular the combined inlet and outlet valve device 36. The stream of air, which, in FIG. 1, is released unpressurized into the pressure-relief chamber 41, in particular the surroundings, is blown here into the chamber between a float valve 43 and a sintered filter 44. The backpressure formed in the sintered filter 44 allows a part of the exhaust air to flow through the float valve into the working chamber 5.4c of the retarder 1.4. In other respects, the design corresponds to that described in FIG. 1.

FIG. 5 elucidates a further field of application in a hydrodynamic retarder 1.5 that includes means 32 for adjusting an optimal degree of filling 32. Further visible are the retarder shaft 64 and the rotational axis 63 of the rotor 4. In this retarder 1.5, situated in the back wall of the stator 3.5 is the operating-substance outlet 7.5, which opens into the extended working chamber 65 arranged behind the stator 3.5. The extended working chamber 65 arranged behind the stator 3.5 includes, once again, an outlet 34, which is also referred to as an overflow edge and is arranged horizontally in the present case and opens into the outlet chamber 33.5, which is associated with an outlet valve 35.5. The horizontally arranged outlet 34 is situated at a height h. In contrast to the conventional retarders in which the outlet is arranged on the bottom, it is ensured in this way that the hydrodynamic retarder 1 can never be completely emptied, even during non-braking operation, and a certain residual quantity of oil circulates in the retarder working chamber 5.5 at all times, that is, in the chamber between the rotor 4.5 and the stator 3.5. Through the appropriate choice of the height h, the quantity of operating substance that, during non-braking operation, remains in the working chamber 5.4 together with the gaseous medium can be adjusted precisely. In this way it is possible, during non-braking operation, to adjust a predetermined filling and thus to adjust the disturbance of the air stream that otherwise sets in and leads to power losses, it being possible to change this in such a way that, at a predetermined speed of rotation, a minimal λ value and thus an optimum with respect to idling losses is obtained. In accordance with the invention, it is provided that this chamber, that is, the outlet chamber 33.5, is also emptied through application of pressure at least partially in order to further minimize here the power loss due, at very high speeds of rotation, to the small residual quantity of oil.

An already optimal quantity of operating substance remaining in the working chamber for the operating range of low speeds of rotation may still be too large for higher speeds of rotation. Here, the excess quantity of operating substance is independently conveyed into the region of the outlet when the speed of rotation increases, that is, on account of the greater pumping action of the rotor.

FIG. 6a elucidates, by way of example, a possible embodiment of a pulse valve 50, such as can be used, for example, as valve device 42 for selective coupling of the ventilation channels 20.6a to a pressure-relief chamber 41.6a or to the means 12.6a.

This comprises a movable piston 49, the piston surfaces of which allow a cross-sectional area of passage between the ventilation channel or channels 20.6a and a ventilation 48 to the surroundings or between the connecting line 13.6a or the means 12.6a coupled to it and the ventilation channel or channels 20.6a. The connection between the ventilation channel 20.6a and the ventilation to the surroundings 48, that is, the pressure-relief chamber 41.6a, is afforded here, in the resting case, by way of a ventilation gap 51. During a pressure pulse from the connecting line 13.6a, an injection gap 52 opens and the ventilation gap closes or at least reduces its cross-sectional area of passage decisively, so that the pressure pulse arrives through the ventilation channel 20.6a into the working chamber, which is not represented here, and displaces the working medium or the operating substance.

FIG. 6b elucidates, by contrast, a further embodiment example of a pulse valve 50, which operates without moving parts. The connecting line 13.6b extends, for this purpose, at an angle in the connecting channel between the ventilation channel 20.6b and ventilation 48 into the surroundings, the opening oriented towards the ventilation channel 20.6b being designed in a nozzle-like manner and there remaining only a small cross-sectional area of passage between the nozzle-like end region and the wall regions of the connection between ventilation channel 20.6b and ventilation 48. The nozzle-like end region forms an injection nozzle 53. The connection between the ventilation channel 20.6b and the ventilation 48 to the surroundings is, in the resting case, afforded through the ventilation gap 51. During a pressure pulse from the connecting line 13.6b, the rapid flow out of the injection nozzle 53 blocks the connection between the ventilation channel 20.6b for the ventilation 48 to the surroundings in such a dynamic manner that the pressure pulse arrives through the ventilation channel 20.6b into the working chamber and there makes possible a displacement of the operating substance. A possible throttle 54 in the channel to the surroundings additionally supports this mode of action and can reduce the requirements placed on the efficiency of the injection nozzle 53 or even eliminate these altogether, so that the construction expenditure for the pulse valve 50 can be reduced.

FIG. 7 elucidates, by way of example, the control scheme of a retarder, in which the exhaust air is drawn out of a valve control in order to empty the working chamber 5.5 through application of pressure. Provided for actuating the retarder 1.7 is a valve control unit 58, which comprises a pilot valve 59 and a proportional valve 61. Associated with the retarder 1.7 is an operating-substance reservoir 39.7. The working chamber 5.7 is coupled to this through an inlet line and an outlet line. The filling of the retarder is influenced by means of a variable pressure, controlled by way of a proportional valve, on the level of operating substance in the operating-substance reservoir 39.7. The operating-substance reservoir 39.7 can be connected through a connecting channel, the cross-sectional area of passage of which can be changed by means of a pneumatically actuated check valve 56, to a compensating chamber 55. The pilot valve 59 closes, through the actuating line 62, the pneumatically actuated check valve 56, which controls the connecting channel 60 between the operating-substance reservoir 39.7 and the compensating chamber 55 and releases compressed air to the proportional valve, which, by means of a variable pressure on the operating-substance reservoir 39.7, operates the retarder 1.7. For termination of the braking process, the pilot valve 59 switches back to its initial position and, through the proportional valve 61, the actuating pressure in the operating-substance reservoir 39.7 is dissipated. At the same time, the control line 62, including the buffer volume 57 in the connecting line 13.7, ventilates and, through the pulse valve 50.7, empties the working chamber 5.7 and the outlet chamber 33.7 through application of pressure.

FIG. 8 elucidates a further embodiment that exploits exhaust air from a valve control. The retarder control corresponds to that described in FIG. 7; the only difference is that, in FIG. 8, the exhaust air is not introduced into the channel 20 for ventilating the working chamber 5.8, but rather is introduced into the feed channel 15.8.

List of Reference Characters

| 1, 1.2, 1.3, 1.4a, 1.4b, 1.5 | hydrodynamic retarder |
|---|---|
| 2, 2.2, 2.3, 2.4a, 2.4b, 2.5 | retarder housing |
| 3, 3.2, 3.3, 3.4a, 3.4b, 3.5 | stator |
| 4, 4.2, 4.3, 4.4a, 4.4b, 4.5 | rotor |
| 5, 5.2, 5.3, 5.4a, 5.4b, 5.5 | working chamber |
| 6, 6.2, 6.3, 6.4a, 6.4b, 6.5 | operating-substance inlet |
| 7, 7.2, 7.3, 7.4a, 7.4b, 7.5 | operating-substance outlet |
| 8 | blade base |
| 9 | blade base |
| 10 | blade mounting of the stator |
| 11 | blade mounting of the rotor |
| 12, 12.2, 12.3, 12.4a, 12.4b, 12.5 | means for introducing gaseous |
| | medium under pressure into the |
| | working chamber |
| 13, 13.2, 13.3, 13.4a, 13.4b, 13.5, | connecting line |
| 13.6a, 13.6b | |
| 14 | means for selective coupling of the |
| | operating-substance inlet 6 with the |
| | means 12 or with an operating- |
| | substance source |
| 15 | inlet line |
| 16 | valve device |
| 17, 17.2, 17.3, 17.4a, 17.4b, 17.5 | inlet for the gaseous medium |
| 18 | opening or channel |
| 19 | ventilation blade |
| 20, 20.6a, 20.6b | ventilation channel |
| 21 | core chamber |
| 22 | inner chamber |
| 23 | wall |
| 24 | means for controlling the utilization |
| | of the line connection or of parts |
| | thereof |
| 25 | reservoir |
| 26 | compressor device |
| 27 | means for generating pressure pulses |
| 28 | pressure pulse cylinder |
| 29 | piston acted upon by pressure |
| 30 | air connection |
| 31 | line |
| 32 | means for adjusting an optimal |
| | degree of filling |
| 33 | outlet chamber |
| 34 | outlet |
| 35 | outlet valve |
| 36 | valve device |
| 37 | outlet line |
| 38 | heat exchanger |
| 39 | operating-substance reservoir |
| 40, 40.6a | means for coupling the ventilation |
| | channels to the pressure-relief |
| | chamber |
| 41, 41.6a, 41.6b | pressure-relief chamber |
| 42 | valve device |
| 43 | float valve |
| 44 | sintered filter |
| 45 | surface of the working medium |
| 46 | ascending channel |
| 47 | junction |
| 48 | ventilation to the surroundings |
| 49 | piston of the pulse valve |
| 50 | pulse valve |
| 51 | ventilation gap |
| 52 | injection gap |
| 53 | injection nozzle |
| 54 | throttle |
| 55 | compensating chamber |
| 56 | pneumatically actuated check valve |
| 57 | buffer volume |
| 58 | valve control unit |
| 59 | pilot valve |
| 60 | connecting channel |
| 61 | proportional valve |
| 62 | actuating line |
| 63 | rotational axis of the retarder |
| 64 | retarder shaft |
| 65 | extended working chamber |

1-41. cancelled

42. A method for emptying an operating substance in an accelerated manner from a working chamber formed between a rotor and a stator of a hydrodynamic retarder, the method comprising the steps of:
introducing a gaseous medium into the working chamber during an emptying process; and
inducing a volume displacement.

43. The method according to claim 42, wherein said gaseous medium is introduced under pressure into the working chamber.

44. The method according to claim 43, further comprising the step of changing a magnitude of pressure in the working chamber thereby adjusting remaining residual quantities of the operating substance.

45. The method according to claim 42, wherein said gaseous medium is introduced into the working chamber based at least in part upon rotation of a rotor-blade wheel.

46. The method according to claim 42, wherein said gaseous medium is introduced into the working chamber at substantially the same time as or with a slight delay to initiation of said emptying process.

47. The method according to claim 46, wherein said initiation of said emptying process occurs based at least in part upon transmission of a signal, said signal representing a command to reduce braking moment, said signal being generated by a driver or a vehicle control computer.

48. The method according to claim 46, wherein said initiation of said emptying process occurs based at least in part upon transmission of a signal, said signal representing a command to deactivate the hydrodynamic retarder, said signal being generated by a driver or a vehicle control computer.

49. The method according to claim 42, wherein said gaseous medium is present in a non-pressurized state and wherein said gaseous medium is compressed prior to being introduced into the working chamber.

50. The method according to claim 42, wherein said gaseous medium is presented in a compressed state as a waste product of a pneumatic control mechanism of an actuating device or of other systems of a drive system in which the hydrodynamic retarder is integrated.

51. The method according to claim 42, wherein said gaseous medium is air.

52. The method according to claim 50, wherein said gaseous medium is formed by exhaust air from a pneumatic control mechanism.

53. The method according to claim 43, wherein said gaseous medium under pressure can be varied in quantity, magnitude of pressure, or both.

54. The method according to claim 53, wherein variation of said quantity or magnitude of pressure of said gaseous medium under pressure occurs in pre-defined intervals of time.

55. The method according to claim 43, wherein introduction of said gaseous medium under pressure into the working chamber is done in one or more pulses.

56. The method according to claim 42, wherein said gaseous medium is introduced into the working chamber through an operating substance inlet.

57. The method according to claim 42, wherein said gaseous medium is introduced into the working chamber through at least one ventilation channel, and wherein the stator, the rotor, or both has a blade mounting with said at least one ventilation channel that is connected to a blade base and a chamber disposed near an outside of the blade wheel.

58. The method according to claim 43, wherein introduction of said gaseous medium under pressure into the working chamber causes at least partial volume displacement of the operating substance present in an outlet chamber of the hydrodynamic retarder, wherein said outlet chamber is disposed downstream of an operating-substance outlet having an outlet valve, and wherein said at least partial volume displacement is influenced by parameters of said gaseous medium selected from the group consisting of density, pressure, temperature, volume, and any combinations thereof.

59. A hydrodynamic retarder in communication with a medium source having a gaseous medium, the hydrodynamic retarder comprising:
a housing;
a stator having a stator housing; and
a rotor, said stator and said rotor forming a working chamber having at least one operating-substance inlet and one operating-substance outlet, wherein said working chamber is in communication with the medium source for introducing the gaseous medium into said working chamber to produce a volume displacement.

60. The hydrodynamic retarder according to claim 59, wherein the gaseous medium is air.

61. The hydrodynamic retarder according to claim 60, further comprising control functions and a valve control, wherein said air is exhaust air produced from said control functions, said valve control, or both.

62. The hydrodynamic retarder according to claim 59, further comprising:
at least one connection line; and
a chamber inlet for said working chamber, wherein said at least one connection line and said chamber inlet are in communication with the medium source, and wherein the gaseous medium that is introduced into said working chamber is a compressed gas.

63. The hydrodynamic retarder according to claim 62, further comprising at least one reservoir for said compressed gas.

64. The hydrodynamic retarder according to claim 63, further comprising at least one compressor for generating said compressed gas, wherein said at least one reservoir for said compressed gas is a pressurized substance reservoir.

65. The hydrodynamic retarder according to claim 64, further comprising a connection controller in communication with said at least one connection line, said connection controller controlling communication between said at least one reservoir and said working chamber.

66. The hydrodynamic retarder according to claim 63, wherein said compressed gas is generated at least-in part by a waste product from a pneumatically controlled actuating device.

67. The hydrodynamic retarder according to claim 62, wherein said chamber inlet is defined at least in part by said operating-substance inlet.

68. The hydrodynamic retarder according to claim 67, further comprising:
a first line being connected to said operating-substance inlet;
a second line having an operating substance therein; and
valving selectively connecting said first line to either said second line or to the medium source.

69. The hydrodynamic retarder according to claim 68, wherein said valving has a controller having first and second switching positions, wherein said second switching position causes supply of said operating substance to said operating-substance inlet to be stopped, and wherein said at least one connection line is connected to said first line.

70. The hydrodynamic retarder according to claim 59, further comprising:
a chamber inlet on said working chamber for introduction of the gaseous medium;
a blade mounting having at least one ventilation blade with a ventilation channel;
a core chamber having a core opening; and
an outer chamber being disposed outside of said stator or said rotor, said ventilation channel connecting said core chamber with said outer chamber, wherein said chamber inlet is at least partially defined by said core opening.

71. The hydrodynamic retarder according to claim 70, further comprising a ventilation controller that selectively allows flow through said ventilation channel or said chamber inlet.

72. The hydrodynamic retarder according to claim 70, further comprising:
a ventilation line; and
a ventilation controller for selectively providing communication between said ventilation line and said ventilation channel or for introducing the gaseous medium into said working chamber from the medium source.

73. The hydrodynamic retarder according to claim 72, further comprising a valve device having first and second switching positions, wherein said ventilation channel is blocked in said second switching position, and wherein said at least one connection line is connected to said ventilation line.

74. The hydrodynamic retarder according to claims 59, further comprising a gas cylinder for compressing the gaseous medium.

75. The hydrodynamic retarder according to claim 59, further comprising a medium controller for controlling introduction of the gaseous medium into said working chamber.

76. The hydrodynamic retarder according to claim 59, wherein the medium source generates pressure pulses of the gaseous medium.

77. The hydrodynamic retarder according to claim 76, further comprising a pressure pulse cylinder for generating said pressure pulses.

78. The hydrodynamic retarder according to claim 77, wherein said pressure pulse cylinder has a piston actuated by pressure.

79. The hydrodynamic retarder according to claims 59, wherein said operating-substance outlet either is disposed radially inward to oppose a centrifugal force in said working chamber or is disposed at an elevated location.

80. The hydrodynamic retarder according to claim 79, wherein said operating-substance outlet is disposed substantially horizontally.

81. The hydrodynamic retarder according to claim 79, wherein said operating-substance outlet comprises a tube extending substantially vertically with a portion thereof extending into said working chamber.
